(19) United States
(12) Patent Application Publication
(10) Pub. No.: US 2010/0088362 A1
(43) Pub. Date: Apr. 8, 2010

(54) INTERNET MEDIA BROADCAST SYSTEM, METHOD THEREFOR, AND RECORDING MEDIUM FOR EXECUTING THE SAME

(75) Inventors: Tsung-Ching Lin, Taipei City (TW); En-Wei Wu, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignees: MTECH Corporation, Ltd., Taipei (TW); I-SHOU UNIVERSITY, Kaohsiung County (TW)

(21) Appl. No.: 12/247,745

(22) Filed: Oct. 8, 2008

(51) Int. Cl. G06F 15/16

(52) U.S. Cl. 709/203

(57) ABSTRACT

An Internet media broadcast system, method therefor and recording medium for executing the same are provided. The Internet media broadcast system includes a server unit, a client unit, and a media dongle. The server unit includes an Internet radio station database and an advertising database respectively with built-in accessible Internet station information and commercial advertisement information. To listen to online broadcast, user plugs the media dongle into the transmission interface of the client unit to enable the automatic execution of the Internet broadcasting software program in the dongle to obtain accessible Internet radio station information and commercial advertisement information via networking and link up to an Internet radio station to listen to the broadcast and the latest sales promotion or information on new products.

### BACKGROUND OF THE INVENTION

1. Field of the Invention

The present invention relates to an Internet media broadcast system, method therefor and recording medium for executing the same, more particularly a system and method for listening to Internet broadcast and product messages via a server unit with a database that stores accessible Internet radio station information and commercial advertisement information, and a client unit which can obtain accessible Internet radio station information and commercial advertisement information with the plug-in of a media dongle.

2. Related Art

Listening to radio is an indispensable part of modern life, for radio shows offer both entertainment and information. In line with the innovations in networking technology, radio broadcasters are digitalizing their service to offer online radio programs via Internet linkup.

However, listening to online radio broadcast nowadays requires the setting of online broadcast software program and searching for broadcast server. For users with little knowledge about computer and/or Internet, the process presents a challenge and inconvenience. In addition, oftentimes not all stations on the online radio station list provided by the online broadcast software program can be linked up if the station has changed its streaming server address or is no longer in service, which can at times be a frustrating experience. In addition, the interface provided by online broadcasting software program is typically used for listening to radio program only and unable to provide the user with instant messages, which in itself is a drawback when a user desires richer information on radio station sites.

### SUMMARY OF THE INVENTION

To address the problem, the invention aims to provide an Internet media broadcast system, method therefor and recording medium for executing the same that allows users to listen to online radio with a media dongle without settings or searching for the radio stations, and in addition, allows users to receive latest commercial or information on new products as a reference for buying goods.

The Internet media broadcast system comprises a server unit, a client unit and a media dongle. The server unit contains an Internet radio station database and an advertising database stored respectively with accessible Internet radio station information and commercial advertisement information, where the Internet radio station database would automatically and periodically test and update the accessible Internet radio station information therein. When a user plugs a transmission connector of the media dongle into the transmission interface of the client unit, it will enable the automatic execution of the Internet broadcasting software program in the media dongle to link up with the server unit so as to obtain the transport stream of accessible radio station information and commercial advertisement information packeted by the server unit according to a media compression code conversion protocol and allow the user to listen to online broadcast and advertisement or information on new products.

The way to listen to online broadcast according to the invention is that the database in the server unit periodically tests and decides whether to update the accessible Internet radio station information according to user settings. When a user desires to listen to online broadcast, the user plugs the transmission connector of the media dongle into the transmission interface of the client unit to enable the automatic execution of the Internet broadcasting software program built in the media dongle, and obtain the accessible Internet radio station information and commercial advertisements stored in the databases of the server unit via the Internet. The user then operates the Internet broadcasting software program to select and listen to the online radio station desired, while commercial advertisement or information on promotion products or discount sales is displayed simultaneously.

The media dongle of the invention comprises a microcontroller, a transmission connector and a memory. The transmission connector is plugged into a client unit with a hot plug and plug-and-play transmission interface. The microcontroller drives the client unit interface to enable the automatic execution of the Internet broadcasting software program built in the memory to allow user to select and listen to the radio and receive advertising messages.

The Internet broadcasting software program is built in the media dongle. When the media dongle is plugged into the client unit for listening to online broadcast, the signal from the media dongle plugged into the hot plug and plug-and-play transmission interface of the client unit would enable the automatic execution of Internet broadcasting software program. At this time, the Internet broadcasting software program would receive the streaming of accessible radio station information and commercial advertisement information packeted in compliance with a media compression code conversion protocol in the server unit. After receiving the user command on the Internet radio station desired, the Internet broadcasting software program would link up to the remote radio station corresponding to the command via the Internet to receive the streaming media information from the radio station. After the client unit parses and decodes the streaming media information, corresponding voice signals are generated and played. The commercial advertisements are also played simultaneously for viewing by the user.

The Internet broadcasting software program can also be implemented through a recording medium where the Internet radio station program recorded in the recording medium is read and executed to address the same problem and achieve the same effect.

The client unit is a personal computer, mobile communication device, or personal digital assistant (PDA), The hot plug and plug-and-play transmission interface is a universal serial bus (USB), IEEE1394 (Firewire), integrated drive electronics (IDE), or secure digital input/output (SDIO). The media compression code conversion protocol is H.264 standard, MPEG-4 standard, advanced audio coding (AAC) standard or adaptive multi-rate (AMR) standard.

The Internet media broadcast system, method therefor and recording medium for executing the same according to the invention utilizes a media dongle, which is plugged into a client unit to execute automatically an Internet broadcasting software program to obtain the accessible Internet radio station information and commercial advertisements in the databases of the server unit. As such, the user can listen to online radio broadcast without settings or searching for radio stations. In addition, while the user is listening to the broadcast, market information on new products, sales promotion or other commercial advertisement is also displayed to introduce all kinds of product information to the user. If the user is sufficiently interested to purchase the product, it is a win-win situation for the consumer and the advertiser.

### BRIEF DESCRIPTION OF THE DRAWINGS

The present invention will become more fully understood from the detailed description given herein below for illustration only, and which thus is not limitative of the present invention, and wherein:

FIG. 1A is a diagram illustrating the Internet media broadcast system according to an embodiment of the invention;

FIG. 1B is a diagram illustrating the Internet media broadcast system according to an embodiment of the invention;

FIG. 1C is a diagram illustrating the Internet media broadcast system according to an embodiment of the invention;

FIG. 1D is a diagram illustrating the Internet media broadcast system according to an embodiment of the invention;

FIG. 2 is the module block diagram of the Internet media broadcast system according to an embodiment of the invention;

FIG. 3 is a diagram illustrating the Internet broadcast software program of the Internet media broadcast system according to the invention;

FIG. 4 is a flow chart of the Internet media broadcast method according to an embodiment of the invention; and

FIG. 5 is a flow chart of the execution of Internet broadcast software program according to an embodiment of the invention.

### DETAILED DESCRIPTION OF THE INVENTION

The objects and features of the invention are described in detail below with embodiments in reference to the accompanying drawings.

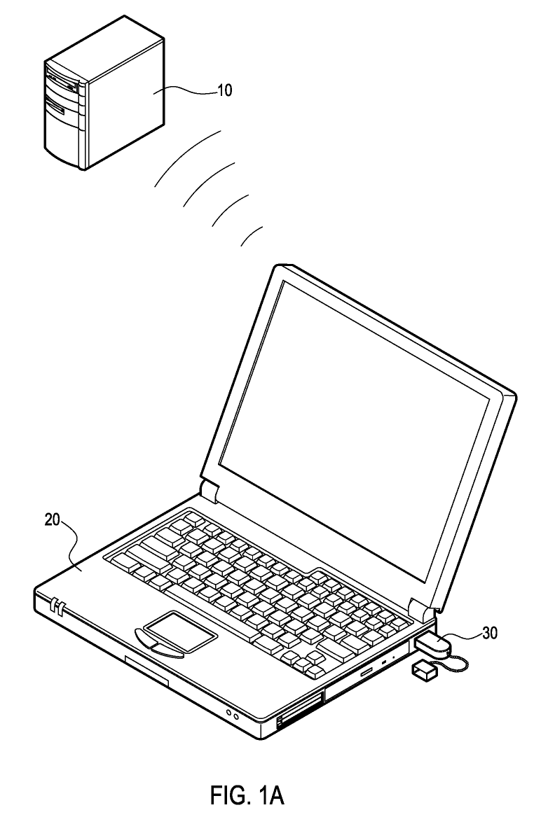

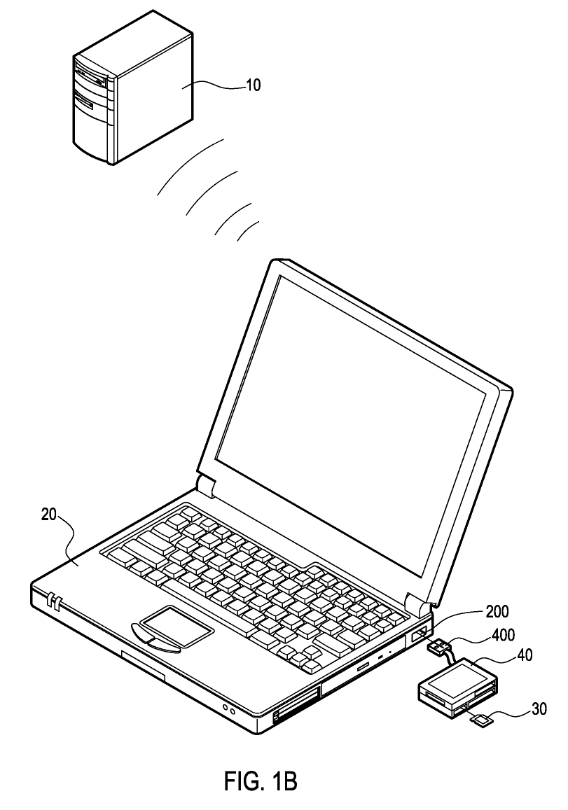

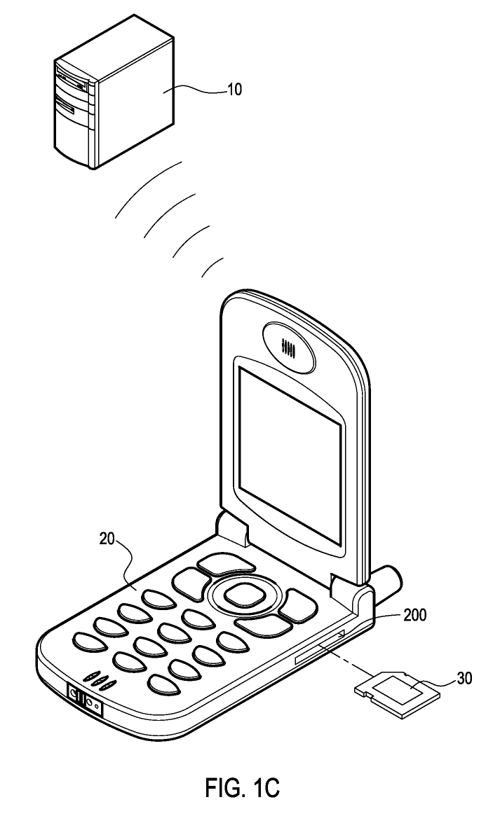

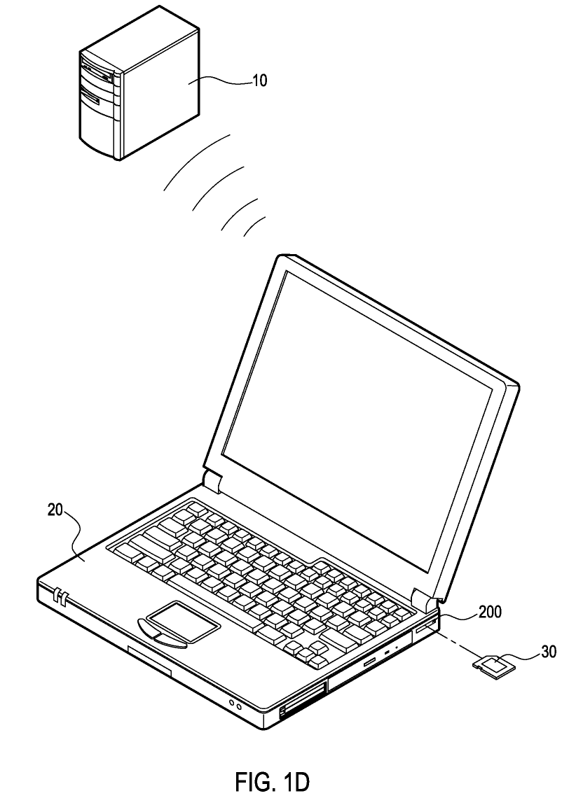

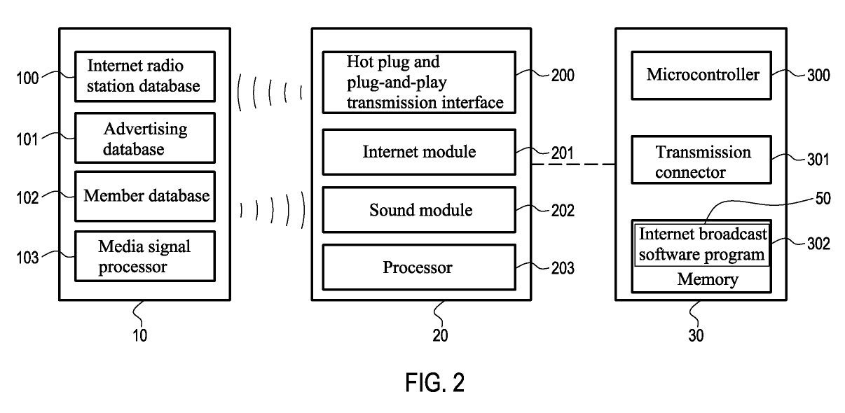

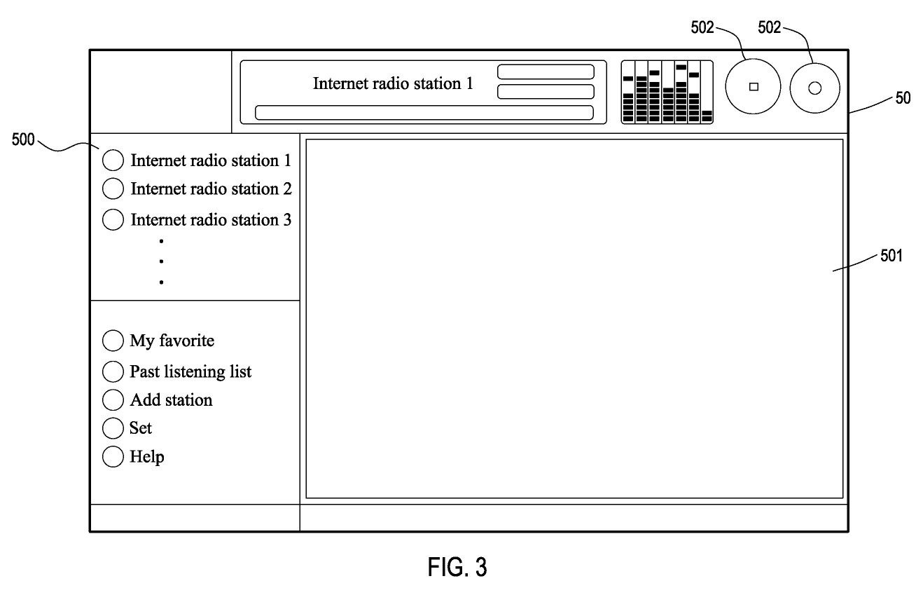

FIG. 1A, FIG. 1B, FIG. 1C and FIG. 1D illustrate the Internet media broadcast system according to an embodiment of the invention. FIG. 2 is the module block diagram of the Internet media broadcast system according to an embodiment of the invention. FIG. 3 shows the Internet broadcast software program of the Internet media broadcast system according to the invention

Referring to FIGS. 1A, 1B, 1C, 1D, 2 and 3, the Internet media broadcast system comprises a server unit 10, a client unit 20, and a media dongle 30. The server unit 10 is built in with an Internet radio station database 100, an advertising database 101, a member database 102, and a media signal processor 103. The client unit 20 comprises a hot plug and plug-and-play transmission interface 200, an Internet module 201, a sound module 202 and a processor 203. The media dongle 30 includes a microcontroller 300, a transmission connector 301 and a memory 302.

The Internet radio station database 100, the advertising database 101 and the member database 102 are respectively stored with accessible Internet radio station information, commercial advertisement information, and prebuilt membership information. The Internet radio station database 100 would, by the streaming address of each Internet radio station in the accessible Internet radio station information, periodically and automatically links to the Internet radio station server to test whether the station is linkable for listening and update the accessible radio station information. The media dongle 30 can be plugged directly into the hot plug and plug-and-play transmission interface 200 of the client unit 20, or the media dongle 30 may be a memory disk or a memory card which can be plugged directly into a memory-card interface of an information converter 40 such as a card reader and linked to the hot plug and plug-and-play transmission interface 200 of the client unit 20 via the information connector 400 of the information converter 40, or plugged into a memory-card interface of an information converter 40 built in the client unit 20. At this time, the microcontroller 300 would drive the interface between the media dongle 30 and the client unit 20 to automatically execute the Internet broadcast software program 50 stored in the memory 302.

The Internet module 201 of the client unit 20 networks with the server unit 10 using the Transmission Control Protocol/Internet Protocol (TCP/IP) or Wireless Local Area Network (WLAN). The media signal processor 103 of the server unit 10 packets the accessible Internet radio station information and commercial advertisement information into transport stream according to a media compression code conversion protocol and sends the stream to the client unit 20. The processor 203 uses the same media compression code conversion protocol to parse the stream and load the accessible Internet radio station information into the Internet broadcast software program 50. An accessible Internet radio station list 500 is then displayed for selection by the user, and commercial advertisement is also played in the ad-zone 501. The Internet module 201 of the client unit 20 would link to the corresponding Internet radio station server according to the user selection to receive the streaming from the station. After the processor 203 of the client unit 20 parses and decodes the streaming information, the sound module 202 would play the information for the user to listen where the sound volume, stereo, mono or dual can be adjusted via a control button 502.

The client unit 20 is a personal computer, mobile communication device, or personal digital assistant (PDA), The hot plug and plug-and-play transmission interface is a universal serial bus (USB), IEEE1394 (Firewire), integrated drive electronics (IDE), or secure digital input/output (SDIO). When the media dongle 30 is a memory disk or a memory card, its memory 302 is a flash memory. The media compression code conversion protocol is H.264 standard, MPEG-4 standard, advanced audio coding (AAC) standard or adaptive multi-rate (AMR) standard.

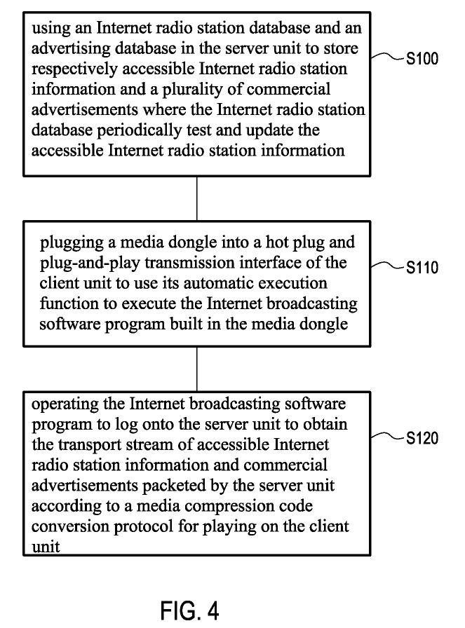

Refer to FIG. 4 which is a flow chart of the Internet media broadcast method according to an embodiment of the invention, the Internet media broadcast method comprises mainly the following steps:

Also refer to FIGS. 1A, 1B, 1C, 1D, 2 and 3 to help understand the working of the Internet media broadcast system.

Use an Internet radio station database and an advertising database in the server unit to store respectively accessible Internet radio station information and a plurality of commercial advertisements where the Internet radio station database periodically test and update the accessible Internet radio station information (step S100). The Internet radio station database 100 and the advertising database 101 of the server unit 10 is respectively stored with accessible Internet radio station information and commercial advertisements, and the Internet radio station database 100 would, by the streaming address of each Internet radio station in the accessible Internet radio station information, periodically and automatically links to the Internet radio station server to test whether the station is linkable for listening and update the accessible radio station information to make sure user can listen to all Internet radio stations he/she chooses.

Plug a media dongle 30 into a hot plug and plug-and-play transmission interface 200 of the client unit 20 to use its automatic execution function to execute the Internet broadcasting software program 50 built in the media dongle 30 (step S110). When a user likes to listen to online broadcast and plug the transmission connector 301 of the media dongle 30 into the hot plug and plug-and-play transmission interface 200 of the client unit 20, the microcontroller 300 of the media dongle 30 communicates with the interface of the client unit 20 and produces a signal to enable the automatic execution of the Internet broadcasting software program 50 built in the memory 302 of the media dongle 30.

Operate the Internet broadcasting software program to log onto the server unit 10 to obtain the transport stream of accessible Internet radio station information and commercial advertisements packeted by the server unit according to a media compression code conversion protocol for playing on the client unit 20 (step S120). The user inputs user name and password to log onto the server unit 10 via the Internet broadcasting software program 50. The server unit 10 would match the accessible Internet radio station information, commercial advertisements, or the user name with the member database 102 to obtain commercial advertisements that fit the user identity, age or preference. The media signal processor 103 would packet such information into transport stream according to the media compression code conversion protocol and deliver the packet to the client unit 20. The processor 203 in the client unit 20 would parse the transport stream using the same compression code conversion protocol to load the accessible Internet radio station information onto the Internet broadcasting software program. An Internet radio station list 500 is then produced for selection by the user, and commercial advertisements are played in the ad-zone 501. User selects the station desired from the Internet radio station list 500 in the Internet broadcasting software program 50 and commands the client unit 20 to link to the corresponding remote Internet radio station via the Internet module 201 and receive the streaming media information. The processor 203 of the client unit 20 parses and decodes the streaming media information and produces corresponding sound signals, which are played by the sound module 202 of the client unit 20. Furthermore, the sound volume, stereo, mono or dual can be adjusted via a control button 502.

Again referring to FIGS. 1A, 1B, 1C, 1D and 2, the media dongle 30 of the invention comprises a microcontroller 300, a transmission connector 310 and a memory 302. The media dongle 30 is applied to a client unit 20 that supports hot plug and plug-and-play transmission interface 200 such as universal serial bus (USB), IEEE1394 (Firewire), integrated drive electronics (IDE), or secure digital input/output (SDIO).

When the user plugs the media dongle 30 into the hot plug and plug-and-play transmission interface 200 of the client unit 20, the media dongle 30 would drive the interface with the client unit 20 via its microcontroller 300 to automatically activate the Internet broadcasting software program 50 stored in the memory 302. The Internet module 201 of the client unit 20 networks with the server unit 10 using the Transmission Control Protocol/Internet Protocol (TCP/IP) or Wireless Local Area Network (WLAN) to obtain the transport stream of accessible radio station information and commercial advertisement information packeted by the server unit 10 according to a media compression code conversion protocol. The processor 203 parses the accessible radio station information and commercial advertisement information and load into the Internet broadcast software program 50. The Internet module 201 of the client unit 20 links to the corresponding Internet radio station server according to the station selected by the user and receives the streaming media information from the station. The processor 203 of the client unit 20 parses and decodes such information to be played by the sound module 202.

The client unit 20 is a personal computer, mobile communication device, or personal digital assistant (PDA). The media dongle 30 is a memory disk or a memory card and its memory 302 is a flash memory.

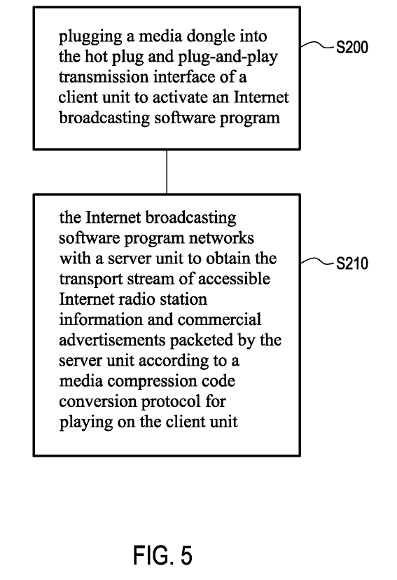

FIG. 5 is a flow chart of the execution of Internet broadcast software program according to an embodiment of the invention, which comprises mainly the following steps:

Also refer to FIGS. 1A, 1B, 1C, 1D, and 2 to help understand the working of the Internet media broadcast system.

Plug a media dongle 30 into the hot plug and plug-and-play transmission interface 200 of a client unit 20 to activate an Internet broadcasting software program 50 (step S200). When a user desires to listen to online broadcast, the user plugs the transmission connector 301 of the media dongle 30 into the hot plug and plug-and-play transmission interface 200 of the client unit 20. The microcontroller 300 of the media dongle 30 then communicates with the interface of the client unit 20 and produces a signal to trigger the automatic execution of the Internet broadcasting software program 50 built in the memory 302 of the media dongle 30.

The Internet broadcasting software program 50 networks with a server unit 10 to obtain the transport stream of accessible Internet radio station information and commercial advertisements packeted by the server unit 10 according to a media compression code conversion protocol for playing on the client unit 20 (step S210). At this time, the user logs onto the server unit 10 via the Internet broadcasting software program 50, and passes the authentication process to obtain the transport stream of accessible Internet radio station information and commercial advertisement information packeted by the server unit 10 according to a media compression code conversion protocol, such as H.264 standard, MPEG-4 standard, advanced audio coding (AAC) standard or adaptive multi-rate (AMR) standard. The user then selects the station desired through the interface of the Internet broadcasting software program 50 and gives command to the Internet broadcasting software program 50. The client unit 20 then links to the corresponding remote Internet radio station via the Internet module 201 to receive the streaming media information from the radio station. The processor 203 of the client unit 20 parses and decodes the streaming media information and produces corresponding sound signals, which are played by the sound module 202 of the client unit 20. The commercial advertisements are also played in the ad-zone 501.

The Internet broadcasting software program can also be implemented through a recording medium where the Internet radio station program recorded in the recording medium is read and executed to address the same problem and achieve the same effect.

The Internet media broadcast system, method therefor and recording medium for executing the same described above is implemented by plugging the media dongle 30 into the hot plug and plug-and-play transmission interface 200 of the client unit 20 and applying the automatic execution function of the client unit 20 to execute the Internet broadcasting software program 50 built in the media dongle 30, and via the Internet, obtain the accessible Internet radio station information and commercial advertisement information in the Internet radio station database 100 of the server unit 10. As such, the user can plug in and listen to an online broadcast without going through tedious settings or radio station search. The Internet broadcasting software program 50 simultaneously provides all kinds of product promotional messages or information on a new product to enhance the consumption desire of user.

The preferred embodiments of the present invention have been disclosed in the embodiments. However the embodiments should not be construed as a limitation on the actual applicable scope of the invention, and as such, all modifications and alterations without departing from the spirits of the invention and appended claims shall remain within the protected scope and claims of the invention.

What is claimed is:

1. An Internet media broadcast system, comprising:
a server unit having an Internet radio station database and an advertising database stored respectively with an accessible Internet radio station information and a plurality of commercial advertisements, the Internet radio station database updating the accessible Internet radio station information automatically;
a client unit networking with the server unit, the client unit having a hot plug and plug-and-play transmission interface; and
a media dongle having a transmission connector with a same interface as the hot plug and plug-and-play transmission interface of the client unit and built in with an Internet broadcasting software program to link to the server unit to obtain the accessible Internet radio station information and the commercial advertisements for playing.

2. The Internet media broadcast system according to claim 1, wherein the media dongle further comprises:
a microcontroller for controlling a communication between the media dongle and the client unit; and
a memory electrically connected to the microcontroller and built in with the Internet broadcasting software program.

3. The Internet media broadcast system according to claim 1, wherein the client unit is a personal computer, a mobile communication device, or a personal digital assistant (PDA).

4. The Internet media broadcast system according to claim 1, wherein the hot plug and plug-and-play transmission interface is a universal serial bus (USB), an IEEE1394 (Firewire), an integrated drive electronics (IDE), or a secure digital input/output (SDIO).

5. The Internet media broadcast system according to claim 1, wherein the media dongle is plugged into a memory-card interface of an information converter built in the client unit.

6. The Internet media broadcast system according to claim 1, wherein the media dongle is plugged into a memory-card interface of an information converter and linked to the hot plug and plug-and-play transmission interface of the client unit via a connector of the information converter.

7. The Internet media broadcast system according to claim 6, wherein the transmission interface for the connector of the information converter is a universal serial bus (USB), an IEEE1394 (Firewire), an integrated drive electronics (IDE), or a secure digital input/output (SDIO).

8. The Internet media broadcast system according to claim 2, wherein the memory is a flash memory.

9. A media broadcasting method, comprising steps of:
providing a server unit having an Internet radio station database and an advertising database to store respectively an accessible Internet radio station information and a plurality of commercial advertisements, the Internet radio station database periodically testing and updating the accessible Internet radio station information therein;
plugging a media dongle into a hot plug and plug-and-play transmission interface of a client unit and applying its automatic execution function to execute an Internet broadcasting software program built in the media dongle; and
operating the Internet broadcasting software program to log onto the server unit to obtain a transport stream of the accessible Internet radio station information and the commercial advertisements packeted by the server unit according to a media compression code conversion protocol for playing.

10. The media broadcasting method according to claim 9, wherein the server unit further includes a member database stored with prebuilt membership information to enable an authentication of member identity when the Internet broadcasting software program logs onto the server unit, and then the transport stream for commercial advertising information matching the member identity is played.

11. The media broadcasting method according to claim 9, wherein the media compression code conversion protocol is an H.264 standard, an MPEG-4 standard, an advanced audio coding (AAC) standard or an adaptive multi-rate (AMR) standard.

12. The media broadcasting method according to claim 9, wherein the hot plug and plug-and-play transmission interface is a universal serial bus (USB), an IEEE1394 (Firewire), an integrated drive electronics (IDE), or a secure digital input/output (SDIO).

13. The media broadcasting method according to claim 9, wherein the media dongle is plugged into a memory-card interface of an information converter built in the client unit.

14. The media broadcasting method according to claim 9, wherein the media dongle is plugged into a memory-card interface of an information converter and linked to the hot plug and plug-and-play transmission interface of the client unit via a connector of the information converter.

15. The media broadcasting method according to claim 14, wherein the transmission interface for the connector of the information converter is a universal serial bus (USB), an IEEE1394 (Firewire), an integrated drive electronics (IDE), or a secure digital input/output (SDIO).

16. A media dongle plugged into a client unit having a hot plug and plug-and-play transmission interface, wherein the media dongle comprises a microcontroller to control a communication of the media dongle with a corresponding transmission connector of the client unit having a same interface, the media dongle having a memory built in with an Internet broadcasting software program.

17. The media dongle according to claim 16, wherein the client unit is a personal computer, a mobile communication device, or a personal digital assistant (PDA).

18. The media dongle according to claim 16, wherein the hot plug and plug-and-play transmission interface is a universal serial bus (USB), an IEEE1394 (Firewire), an integrated drive electronics (IDE), or a secure digital input/output (SDIO).

19. The media dongle according to claim 16, wherein the media dongle is plugged into a memory-card interface of an information converter built in the client unit.

20. The media dongle according to claim 16, wherein the media dongle is plugged into a memory-card interface of an information converter and linked to the hot plug and plug-and-play transmission interface of the client unit via a connector of the information converter.

21. The media dongle according to claim 20, wherein the transmission interface for the connector of the information converter is a universal serial bus (USB), an IEEE1394 (Firewire), an integrated drive electronics (IDE), or a secure digital input/output (SDIO).

22. The media dongle according to claim 16, wherein the memory is a flash memory.

23. An Internet broadcasting software program stored in a media dongle, comprising procedures of:
plugging the media dongle into a hot plug and plug-and-play transmission interface of a client unit to activate the Internet broadcasting software program; and
the Internet broadcasting software program networking with a server unit to obtain a transport stream of an accessible Internet radio station information and a plurality of commercial advertisement information packeted by the server unit according to a media compression code conversion protocol for playing.

24. The Internet broadcasting software program according to claim 23, wherein the client unit is a personal computer, a mobile communication device, or a personal digital assistant (PDA).

25. The Internet broadcasting software program according to claim 23, wherein the media compression code conversion protocol is an H.264 standard, an MPEG-4 standard, an advanced audio coding (AAC) standard or an adaptive multi-rate (AMR) standard.

26. A recoding medium readable by an electronic device, wherein an Internet broadcasting software program for playing a transport stream of an accessible Internet radio station information and a plurality of commercial advertisement information is recorded therein, steps for executing the Internet broadcasting software program comprising:
plugging a media dongle into a hot plug and plug-and-play transmission interface of a client unit to activate the Internet broadcasting software program; and
the Internet broadcasting software program networking with a server unit to obtain the transport stream of the accessible Internet radio station information and the plurality of commercial advertisement information packeted by the server unit according to a media compression code conversion protocol for playing.

27. The recording medium according to claim 26, wherein the electronic device is a personal computer, a mobile communication device, or a personal digital assistant (PDA).

28. The recording medium according to claim 26, wherein the media compression code conversion protocol is an H.264 standard, an MPEG-4 standard, an advanced audio coding (AAC) standard or an adaptive multi-rate (AMR) standard.
